(19) United States
(12) Patent Application Publication
(10) Pub. No.: US 2020/0372266 A1
(43) Pub. Date: Nov. 26, 2020

(54) IN-VEHICLE SYSTEM

(71) Applicant: Yazaki Corporation, Tokyo (JP)

(72) Inventors: Shinichi Okamoto, Shizuoka (JP); Kentaro Otomo, Shizuoka (JP); Atsushi Ishibashi, Shizuoka (JP); Yu Kawahara, Shizuoka (JP); Masaki Saito, Shizuoka (JP)

(73) Assignee: Yazaki Corporation, Tokyo (JP)

(21) Appl. No.: 16/988,803

(22) Filed: Aug. 10, 2020

Related U.S. Application Data
(63) Continuation of application No. PCT/JP2019/002101, filed on Jan. 23, 2019.

(30) Foreign Application Priority Data
Mar. 12, 2018 (JP) 2018-043903

(51) Int. Cl. G06K 9/00; B60W 30/18

(52) U.S. Cl. CPC G06K 9/00805; B60W 30/181; B60W 2554/4048; B60W 2554/4047; B60W 2554/4029

(57) ABSTRACT

An in-vehicle system includes: a detection unit that detects visual line information of a passerby on the basis of an image obtained by capturing an image in front of a vehicle; a decision unit that decides a motion of the vehicle on the basis of the visual line information of the passerby which is detected by the detection unit; and operation units which perform processing corresponding to the motion of the vehicle which is decided by the decision unit. As a result, the in-vehicle system can attain an effect capable of improving communication between the vehicle and the passerby on the basis of the visual line information of the passerby.

### CROSS-REFERENCE TO RELATED APPLICATION(S)

This application is a continuation of PCT International Application No. PCT/JP2019/002101 filed on Jan. 23, 2019 which claims the benefit of priority from Japanese Patent Application No. 2018-043903 filed on Mar. 12, 2018, the entire contents of which are incorporated herein by reference.

### BACKGROUND OF THE INVENTION

### 1. Field of the Invention

The present invention relates to an in-vehicle system.

### 2. Description of the Related Art

A vehicle of the related art attempts to reduce a sense of uneasy applied to pedestrians through execution of various notifications with respect to pedestrians at the periphery of the vehicle. For example, Japanese Patent Application Laid-open No. 2015-174541 discloses an in-vehicle device that detects a positional relationship between a vehicle and human beings by using a sensor, and a movable device is rotated toward human beings at the periphery of the vehicle on the basis of the detection result.

The vehicle of the related art attempts to reduce a sense of uneasy applied to pedestrians, but there is a room for an improvement from the viewpoint of communication from the pedestrians to the vehicle.

### SUMMARY OF THE INVENTION

The invention has been made in consideration of such circumstances, and an object thereof is to provide an in-vehicle system capable of improving communication between a vehicle and passersby.

In order to achieve the above objection, an in-vehicle system according to one aspect of the present invention includes a detection unit that detects visual line information of a passerby on the basis of an image obtained by capturing an image in front of a vehicle; a decision unit that decides a motion of the vehicle on the basis of the visual line information of the passerby that is detected by the detection unit; and an operation unit that performs processing corresponding to the motion of the vehicle that is decided by the decision unit, wherein the decision unit decides a motion of the vehicle that gives way to the passerby in a case where the visual line information of the passerby faces the vehicle, the operation unit performs processing of outputting first information that indicates that way is given to the passerby to the passerby, the in-vehicle system further includes a first determination unit that determines whether or not the passerby understands the first information output by the operation unit on the basis of a captured image of the passerby, in a case where the first determination unit determines that the passerby understands the first information, the decision unit decides an operation of stopping the vehicle, and the operation unit performs processing corresponding to the operation of stopping the vehicle.

According to another aspect of the present invention, in the in-vehicle system, the passerby may be a person who is likely to traverse a forward side of the vehicle.

According to still another aspect of the present invention, the in-vehicle system may further includes a second determination unit that determines whether or not the passerby makes an action of giving way on the basis of a captured image of the passerby in a case where a visual line of the passerby does not face the vehicle, wherein in a case where the second determination unit determines that the passerby makes an action of giving way, the decision unit may decide an operation of allowing the vehicle to travel, and the operation unit may perform processing corresponding to the operation of allowing the vehicle to travel.

According to still another aspect of the present invention, in the in-vehicle system, in a case where the second determination unit determines that, the passerby does not make an action of giving way, the decision unit may decide an operation of stopping the vehicle or allowing the vehicle to travel slowly, and the operation unit may perform processing corresponding to the operation of stopping the vehicle or allowing the vehicle to travel slowly.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a schematic configuration of an in-vehicle system according to an embodiment;

FIG. 2 is a diagram illustrating an example of passersby who are detected by the in-vehicle system according to the embodiment;

FIG. 3 is a flowchart illustrating an example of control of a control device of the in-vehicle system according to the embodiment;

FIG. 4 is a flowchart illustrating an example of first processing illustrated in FIG. 3;

FIG. 5 is a flowchart illustrating an example of second processing illustrated in FIG. 3; and

FIG. 6 is a flowchart illustrating an example of third processing illustrated in FIG. 3.

### DETAILED DESCRIPTION OF THE PREFERRED EMBODIMENTS

Hereinafter, an embodiment of the invention according to the invention will be described in detail with reference to the accompanying drawings. Furthermore, the invention is not limited by the embodiment. In addition, constituent elements in the following embodiment include a constituent element that can be easily substituted by those skilled in the art, or substantially the same constituent element.

### Embodiment

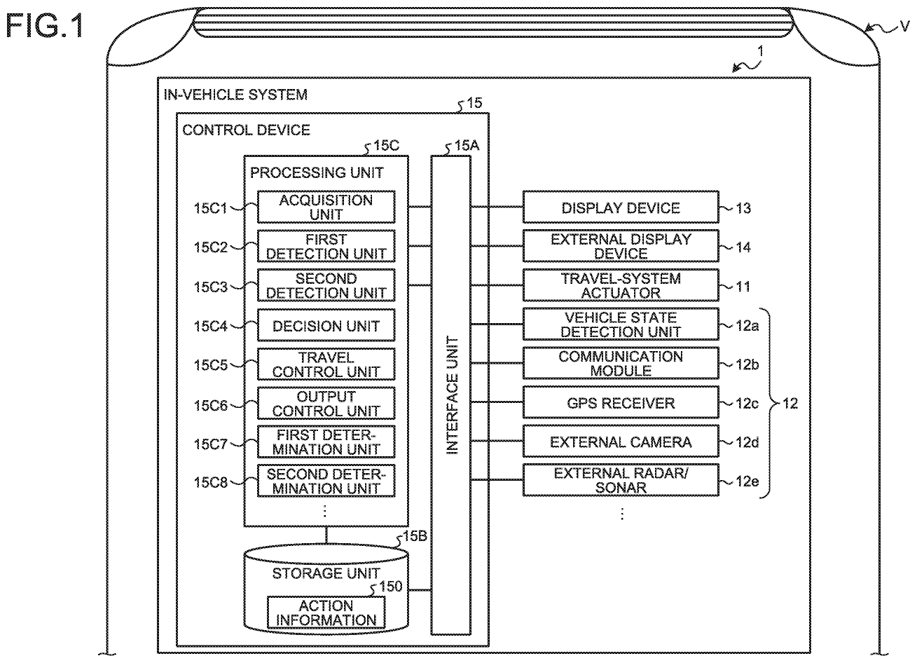

An in-vehicle system 1 of this embodiment illustrated in FIG. 1 is a system that is applied to a vehicle V. The vehicle V to which the in-vehicle system 1 is applied may be any vehicle such as an electric vehicle (EV), a hybrid electric vehicle (HEV), a plug-in hybrid electric vehicle (PHEV), a gasoline vehicle, and a diesel vehicle which use a motor or an engine as a drive source. In addition, driving of the vehicle V may be any driving such as manual driving by a driver, semi-automatic driving, and full-automatic driving. In addition, the vehicle V may be any one of a private vehicle that is carried by a so-called individual, a rent car, a sharing, car, a bus, a taxi, and a ride shared car.

In the following description, as an example, description will be given on the assumption that the vehicle V is a vehicle for which automatic driving (semi-automatic driving, full-automatic driving) is possible. The in-vehicle system 1 assumes intension of a signal of other vehicles to realize the so-called automatic driving in the vehicle V. The in-vehicle system 1 is realized by mounting constituent elements illustrated in FIG. 1 on the vehicle V. Herinafter, respective configurations of the in-vehicle system 1 will be described in detail with reference to FIG. 1. In the following description, the vehicle V may be noted as “host vehicle” in some cases.

Furthermore, in the in-vehicle system 1 illustrated in FIG. 1, a connection method between respective constituent elements for power supply, and transmission and reception of control signals, various pieces of information, and the like may be any one of wired connection through a wiring material such as an electric wire and an optical fiber (including, for example, optical communication through the optical fiber, and the like), wireless communication, and wireless connection such as non-contact power supply unless otherwise stated.

In the following description, description will be given of an example of a case where the in-vehicle system 1 is an automatic driving system.

The in-vehicle system 1 is a system that realizes automatic driving in the vehicle V. The in-vehicle system 1 is realized by mounting the constituent elements illustrated in FIG. 1 on the vehicle V. Specifically, the in-vehicle system 1 includes a travel-system actuator 11, a detection device 12, a display device 13, an external display device 14, and a control device 15.

The travel-system actuator 11 corresponds to various devices for allowing the vehicle V to travel. Typically, the travel-system actuator 11 includes a travel power train, a steering device, a braking device, and the like. The travel power train is a drive device that allows the vehicle V to travel. The steering device is a device that realizes steering of the vehicle V. The braking device is a device that performs braking of the vehicle V.

The detection device 12 detects various pieces of information. For example, The detection device 12 detects vehicle state information, nearby situation information, and the like. The vehicle state information is information indicating a travel state of the vehicle V. The nearby situation information is information indicating a nearby situation of the vehicle V. For example, the vehicle state information may include vehicle speed information of the vehicle V, acceleration (acceleration in a vehicle front and rear direction, acceleration in a vehicle width direction, acceleration in a vehicle rolling direction, and the like) information, steering angle information, accelerator pedal operation amount (accelerator stepping amount) information, brake pedal operation amount (brake stepping amount) information, shift position information, current value/voltage value information of respective units, electricity storage amount information of an electrical storage device, and the like. For example, the nearby situation information may include nearby image information obtained by capturing an image of a nearby environment of the vehicle V or an external object such as a person, other vehicles, and an obstacle at the periphery of the vehicle V, external object information indicating presence and absence of the external object or a relative distance from the external object, a relative speed, and time-to-collision (TTC), and the like, white-line information of a lane in which the vehicle V travels, traffic information of a travel road on which the vehicle V travels, current position information (GPS information) of the vehicle V, and the like.

As an example, the detection device 12 illustrated in FIG. 1 includes a vehicle state detection unit 12a, a communication module 12b, a GPS receiver 12c, an external camera 12d, and an external radar/sonar 12e.

The vehicle state detection unit 12a detects vehicle state information including vehicle speed information, acceleration information, steering angle information, accelerator pedal operation amount information, brake pedal operation amount information, shift position information, current value/voltage value information, electricity storage amount information, and the like. For example, the vehicle state detection unit 12a includes various detectors and sensors such as a vehicle speed sensor, an acceleration sensor, a steering angle sensor, an accelerator sensor, a brake sensor, a shift position sensor, and a current/voltage meter. The vehicle state detection unit 12a may include a processing unit such as an electronic control unit (ECU) that controls respective units in the vehicle V.

The communication module 12b transmits and receives information through wireless communication with external devices of the vehicle V such as other vehicles, of devices, cloud devices, and electronic devices carried by persons outside the vehicle V. According to this, the communication module 12b detects nearby situation information including, for example, nearby image information, external object information, and traffic information. For example, the communication module 12b communicates with external devices through various types of wireless communication such as wide-area wireless type and narrow-area wireless type. Here, examples of the wide-area wireless type include a radio (AM, FM), a TV (UHF, 4K, 8K), TEL, UPS, WiMAX (registered trademark), and the like. In addition, examples of the narrow-area wireless type include ETC/DSRC, VICS (registered trademark), wireless LAN, millimeter wave communication, and the like.

The GPS receiver 12c detects current position information indicating a current position of the vehicle V as the nearby situation information. The GPS receiver 12c receives an electric wave transmitted from a GPS satellite to acquire GPS information (latitude/longitude coordinates) of the vehicle V as the current position information.

The external camera 12d captures an image of the periphery of the vehicle V which constitutes the nearby image information, or an image of a travel road surface of the vehicle V which constitutes white-line information as the nearby situation information. For example, the image includes a moving image, a still image, and the like. The external camera 12d captures an image in front of the vehicle V. For example, the nearby situation information includes a forward image obtained by capturing forward other vehicles travelling in a lane in which the vehicle V travels, and in an opposite lane. For example, the nearby situation information includes images of a lane in front of the vehicle V, and a sidewalk along the lane. For example, the nearby situation information includes an image capable of determining a face position, a facial expression, a visual line, an action, and the like of a passerby. For example, the passerby includes a pedestrian, a human being who rides on a bicycle, a human being who is standing still, and the like.

The external radar/sonar 12e detects external object information by using infrared rays, millimeter waves, ultrasonic waves, and the like as the nearby situation information. For example, the external object information includes information of a passerby on a sidewalk, a road, and the like.

The display device 13 is provided in the vehicle V, and can be visually observed from a driver, an occupant, and the like of the vehicle V. Examples of the display device 13 include display devices such as a liquid crystal display, and an organic electroluminescence (EL) display. The display device 13 can be used, for example, as a combination meter, a head up display, a television, and the like of the vehicle V. The display device 13 may be a known navigation device.

The external display device 14 is provided in the vehicle V, and can display various pieces of information with respect to persons outside the vehicle V. The external display device 14 can be visually observed by persons outside the vehicle V. For example, the external display device 14 includes the display device that is provided in the vehicle V to be visually observed by persons outside the vehicle V. For example, the external display device 14 includes display devices which display various pieces of information on a windshield, a side door, and the like of the vehicle V. In this embodiment, the external display device 14 displays information such as an image, a message, and the like with respect to passersby.

The control device 15 collectively controls respective units of the in-vehicle system 1. The control device 15 may be also used as an electronic control unit that collectively controls the entirety of the vehicle V. The control device 15 executes various kinds of operation processing for realizing travelling of the vehicle V. The control device 15 includes an electronic circuit that mainly includes a known microcomputer including a central operation processing device such as a central processing unit (CPU), a micro processing unit (MPU), an application specific integrated circuit (ASIC), a field programmable gate array (FPGA), a read only memory (ROM), a random access memory (RAM), and an interface. The travel-system actuator 11, the detection device 12, the display device 13, and the external display device 14 are electrically connected to the control device 15. The travel-system actuator 11, the detection device 12, the display device 13, and the external display device 14 may be electrically connected to the control device 15 through an ECU (for example, a body ECU, and the like) that controls respective units in the vehicle V. The control device 15 can transmit and receive various detection signals or various electric signals such as drive signals for driving respective units to and from respective units.

Specifically, the control device 15 includes an interface unit 15A, a storage unit 15B, and a processing unit 15C in terms of a functional concept. The interface unit 15A, the storage unit 15B, and the processing unit 15C can transmit and receive various pieces of information to and from various devices which are electrically connected thereto.

The interface unit 15A is an interface that transmit and receive various pieces of information to and from respective units of the in-vehicle system 1 such as the travel-system actuator 11 and the detection device 12. In addition, the interface unit 15A can be electrically connected to the display device 13 and the external display device 14. The interface unit 15A has an information wired communication function with respective units through an electric wire, an information wireless communication function with the respective units through a wireless communication unit and the like.

The storage unit 15B is a storage device of an automatic driving system. For example, the storage unit 15B may be a data rewritable semiconductor memory such as storage devices including a hard disk, a solid state drive (SSD), and an optical disc which have a relatively large capacity, a RAM, a flash memory, and a nonvolatile static random access memory (NVSRAM). The storage unit 15B stores condition or information which is necessary for various kinds of processing in the control device 15, various programs and applications which are executed by the control device 15, control data, and the like. For example, the storage unit 15B stores map information indicating a map which is referenced when specifying a current position of the vehicle V on the basis of a current position information detected by the GPS receiver 12c, action information 150 that can be used to determine an action of a passerby to be described later, and the like as a database. In addition, for example, the storage unit 15B may temporarily store various pieces of information detected by the detection device 12, and various pieces of information acquired by an acquisition unit 15C1 to be described later. The above-described various pieces of information are read out from the storage unit 15B by the processing unit 15C and the like as necessary.

The processing unit 15C is a unit that executes various programs stored in the storage unit 15B on the basis of various input signals and the like, and outputs an output signal to respective units in accordance with the operation of the programs to execute various kinds of processing for realizing various functions.

More specifically, the processing unit 15C includes the acquisition unit 15C1, a first detection unit 15C2, a second detection unit 15C3, a decision unit 15C4, a travel control unit 15C5, an output control unit 15C6, a first determination unit 15C7, and a second determination unit 15C8 in terms of a functional concept.

The acquisition unit 15C1 is a unit having a function capable of executing processing of acquiring various pieces of information which are used in various kinds of processing in the in-vehicle system 1. The acquisition unit 15C1 acquires the vehicle state information, the nearby situation information, and. the like which are detected by the detection device 12. For example, the acquisition unit 15C1 acquires nearby situation information including an image in front of the vehicle V. The acquisition unit 15C1 can store the acquired various pieces of information in the storage unit 15B.

The first detection unit 15C2 is a unit having a function capable of executing processing of detecting a passerby on the basis of a video (image) obtained by capturing an image in front of the vehicle V. The first detection unit 15C2 detects a passerby who is likely to traverse a forward side of the vehicle V. Examples of the passerby who is likely to traverse the forward side of the vehicle V include a person who moves toward a road on which the vehicle V travels, a person who is standing still on a road side of the road, and the like. Furthermore, the first detection unit 15C2 may be configured to perform detection of a passerby in a case where an object in front of the vehicle V is detected by the external radar/sonar 12e.

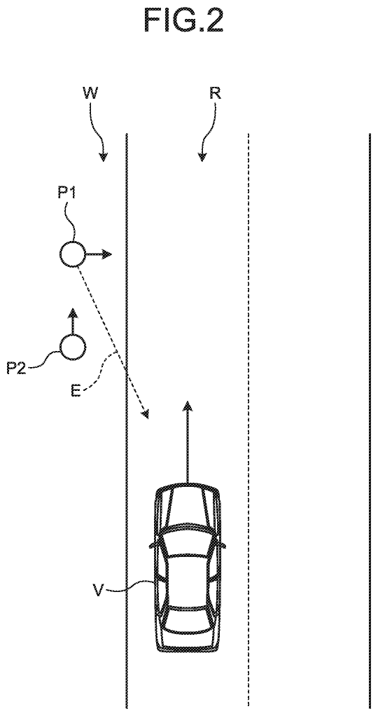

In an example illustrated in FIG. 2, the vehicle V travels on the road R. Two passersby P1 and P2 walk on a sidewalk W in front of the vehicle V. A passerby P1 walks on the sidewalk W toward the road R on a forward side of the vehicle V. Visual line information P of the passerby P1 faces the vehicle V. A passerby P2 faces the same direction as an advancing direction of the vehicle V and walks on the sidewalk W. Visual line information of the passerby P2 does not face the vehicle V. Here, visual line information E is information capable of identifying visual line directions of the passersby P1 and P2. For example, the visual line information E includes information indicating a visual line direction of a passerby. In a situation illustrated in FIG. 2, the passersby P1 and P2 are included in an image obtained by capturing an image in front of the vehicle V by the external camera 12d of the in-vehicle system 1. With regard to a passerby that is to be set as a target passerby on the basis of a video (image) obtained by capturing an image in front of the vehicle V, the first detection unit 15C2 detects the passerby P1 who walks toward the road R as a target passerby. Accordingly, the first detection unit 15C2 can detect a passerby to whom attention should be paid among a plurality of passersby who are in front of the vehicle V.

Returning to FIG. 1, the second detection unit 15C3 is a unit having a function capable of executing processing of detecting visual line information of the passerby detected by the first detection unit 15C2 on the basis of the video (image) obtained by capturing an image in front of the vehicle V. For example, the second detection unit 15C3 specifies a nearby feature of an eye such as a corner of an eye, a tail of the eye, and a pupil of the passerby from the image, and detects the visual line information E indicating a visual line direction of the passerby. For example, the second detection unit 15C3 may specify a direction of a face, the head, and the like from the image, and may detect the visual line information E indicating the visual line direction of the passerby from the above-described direction.

The decision unit 15C4 is a unit having a function capable of executing processing of deciding a motion of the vehicle V on the basis of the visual line information of the passerby which is detected by the second detection unit 15C3. For example, the decision unit 15C4 is configured to execute processing of deciding a motion of the vehicle V by using various known artificial intelligence technologies or deep learning technologies. The decision unit 15C4 can decide the motion of the vehicle V which corresponds to the visual line information of the passerby by using an algorithm, a database, and the like which are based on a learning result of the visual line information of the passerby and an action of the passerby by various methods using the artificial intelligence technologies or the deep learning technologies.

For example, the decision unit 15C4 decides the motion of the vehicle V which corresponds to the visual line information E of the passerby on the basis of the action information 150 stored in the storage unit 15B, and the like. For example, the action information 150 is information that reflects a learning result of a relationship between the visual line information E and the action of the passerby by various methods using the artificial intelligence technologies or the deep learning technologies. In other words, the action information 150 is database information obtained by various methods using the artificial intelligence technologies or the deep learning technologies to define a motion of the vehicle V which corresponds to visual line information and an action of a passerby. Furthermore, an example in which the decision unit 15C4 decides the motion of the vehicle V will be described later.

The travel control unit 15C5 is a unit having a function capable of executing processing of controlling travel of the vehicle V on the basis of a decision result of the decision unit 15C4. The travel control unit 15C5 is an example of an operation unit. The travel control unit 15C5 controls the travel-system actuator 11 on the basis of the information (vehicle state information, nearby situation information, and the like) acquired by the acquisition unit 15C1 to execute various kinds of processing relating to travel of the vehicle V. The travel control unit 15C5 may control the travel-system actuator 11 through an ECU (for example, a body ECU and the like). The travel control unit 15C5 of this embodiment automatically drives the vehicle V by executing various kinds of processing relating to automatic driving of the vehicle V.

The automatic driving of the vehicle V by the travel control unit 15C5 is driving in which a behavior of the vehicle V is automatically controlled in a state in which priority is given to a driving operation by a driver of the vehicle V on the basis of information acquired by the acquisition unit 15C1, or regardless of the driving operation by the driver. Examples of the automatic driving include semi-automatic driving in which the driving operation by the driver is interposed to a certain extent, and full-automatic driving in which the driving operation by the driver is not interposed. Examples of the semi-automatic driving include driving such as vehicle stability control (VSC), adaptive cruise control (ACC), and lane keeping assist (LKA). Examples of the full-automatic driving include driving in which the vehicle V is allowed to automatically travel to a destination, a plurality of the vehicles V are allowed to automatically travel in a line, and the like. In the case of the full-automatic driving, the driver may not exist in the vehicle V. In addition, the travel control unit 15C5 of this embodiment performs control in which a motion of the vehicle V is reflected on travel of the vehicle V in correspondence with visual line information of a passerby by the decision unit 15C4. In other words, the travel control unit 15C5 performs automatic driving of the vehicle V on the basis of a decision result by the decision unit 15C4.

The output control unit 15C6 is a unit having a function capable of executing processing of outputting information indicating a message, an image, and the like with respect to a passerby. The output control unit 15C6 is an example of an operation unit. The output control unit 15C6 displays first information related to a passerby on the external display device 14 through the interface unit 15A. For example, the first information includes information indicating that way is given to a passerby. The output control unit 15C6 causes the external display device 14 to display second information indicating expression of appreciation for the passerby through the interface unit 15A. In this embodiment, description has been given of a case where the output control unit 15C6 outputs the first information, the second information, and the like to the external display device 14, but there is no limitation thereto. For example, the output control unit 15C6 may output the first information, the second information, and the like from a voice output device.

For example, the external display device 14 displays information that is input from the output control unit 15C6 toward the outside of the vehicle V. The external display device 14 displays the first information, the second information, and the like with respect to a passerby, and thus it is possible to realize communication between the passerby and the vehicle V.

The first determination unit 15C7 is a unit having a function capable of executing processing of determining whether or not the passerby understands the first information output from the output control unit 15C6 on the basis of an image obtained by capturing an image of a target passerby. For example, in a case where a facial expression, a gesture, and the like of the target passerby can be detected from the image on the basis of the action information 150 stored in the storage unit 15B, and the like, the first determination unit 15C7 determines that the passerby understands the first information. For example, the action information 150 is information that reflects a learning result of the facial expression, the gesture, and the like in a case where the passerby (person) understands information that is delivered by various methods using the artificial intelligence technologies or the deep learning technologies. That is the first determination unit 15C7 can determines whether or not information indicating that way is given to the passerby can be delivered to the target passerby. As a result, in a case where information indicating that way is given to the passerby can be delivered to a target passerby, the decision unit 15C4 can decide an operation of stopping the vehicle V or of causing the vehicle V to travel slowly. Furthermore, hereinafter, description will be given of a case where the in-vehicle system 1 stops the vehicle V, but there is no limitation thereto. For example, the decision unit 15C4 of the in-vehicle system 1 may further determine whether or not the vehicle V and a passerby are spaced away from each other by a constant distance, and in a case where the vehicle V and a passerby are spaced away from each other by the constant distance, the decision unit 15C4 may decide the operation of causing the vehicle V to travel slowly.

The second determination unit 15C8 is a unit having a function capable of executing processing of determining whether or not the passerby takes an action of giving way on the basis of a captured image of the passerby in a case where a visual line of the target passerby does not face the vehicle. For example, in a case where an action of giving way by the target passerby can be detected from the image on the basis of the action information 150 stored in the storage unit 15B, and the like, the second determination unit 15C8 determines that the passerby makes an action of giving way. For example, the action information 150 is information that reflects a learning result of an action in a case where the passerby gives way by various methods using the artificial intelligence technologies or the deep learning technologies. For example, the action of giving way includes a state in which the passerby stretches a hand toward a forward side. In addition, for example, the action information 150 includes information that reflects a learning result of an action in a case where the passerby does not give way by various methods using the artificial intelligence technologies or the deep learning technologies. For example, in at least one of a case where the passerby makes an action of appreciation, a case where the passerby does not stop, and a case where the center of gravity of the passerby is inclined to a front side, the second determination unit 15C8 determines that the passerby does not make an action of giving way. That is, the first determination unit 15C7 can determine whether or not a passerby whose visual line does not face the vehicle V makes an action of giving way. As a result, in a case where the passerby gives way, the decision unit 15C4 can decides an operation of causing the vehicle V to travel.

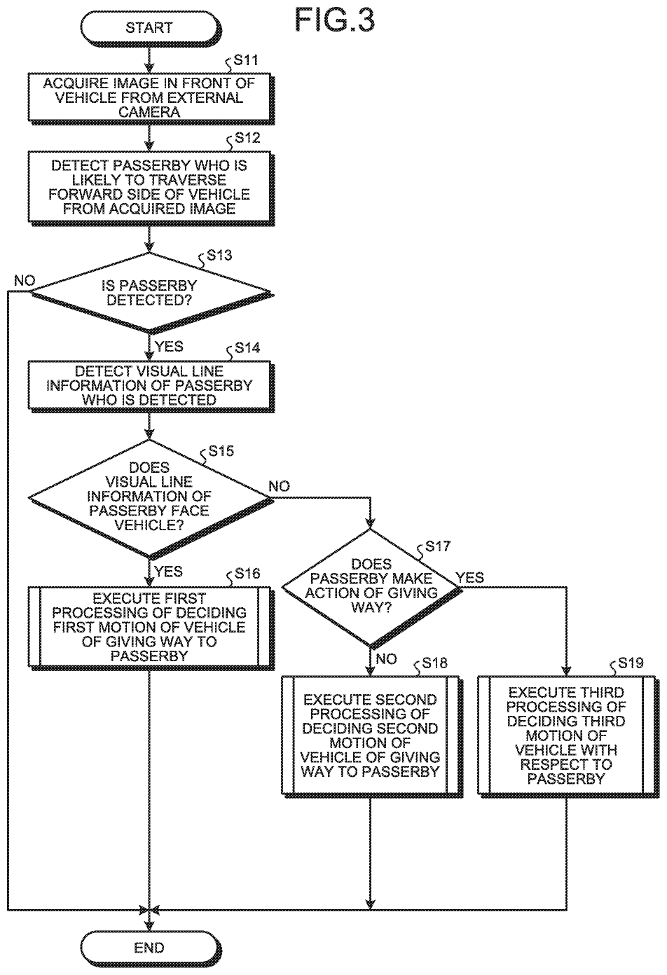

Next, an example of control of the processing unit 15C of the control device 15 will be described with reference to a flowchart of FIG. 3. The flowchart illustrated in FIG. 3 illustrates an example of a procedure of the in-vehicle system 1 which corresponds to a passerby in front of the vehicle V. The procedure illustrated in FIG. 3 is realized when the processing unit 15C executes a program. The procedure illustrated in FIG. 3 is repetitively executed by the processing unit 15C. For example, the procedure illustrated in FIG. 3 is repetitively executed by the processing unit 15C at a control cycle of several ms or several tens of ms (clock unit).

First, the processing unit 15C of the control device 15 of the in-vehicle system 1 acquires an image in front of the vehicle V from the external camera 12d (Step S11). The processing unit 15C detects a passerby who is likely to traverse a forward side of the vehicle V from the image that is acquired. (Step S12). For example, the processing unit 15C detects a passerby from the image through pattern matching and the like. In addition, for example, the processing unit 15C detects a person who faces a road, a person who is standing still on a road side of the road, and the like as a passerby who is likely to traverse the front side of the vehicle. The processing unit 15C functions as the first detection unit 15C2 by executing processing in Step S12. When a detection result indicating whether or not the passerby is detected is stored in the storage unit 15B, the processing unit 15C causes the processing to proceed to Step S13. Furthermore, in the case of detecting the passerby, the detection result includes information related to the passerby.

The processing unit 15C determines whether or not the passerby is detected with reference to the detection result in the storage unit 15B (Step S13). In a case where it is determined that the passerby is not detected (No in Step S13), the processing unit 15C terminates the procedure illustrated in FIG. 3. In a case where it is determined that the passerby is detected (Yes in Step S13), the processing unit 15C causes the processing to proceed to Step S14.

The processing unit 15C detects visual line information of the passerby who is detected (Step S14). For example, the processing unit 15C detects the visual line information of the target passerby on the basis of the image obtained by capturing an image in front of the vehicle V. The processing unit 15C functions as the second detection unit 15C3 by executing the processing in Step S14. When the detected visual line information is stored in the storage unit 15B, the processing unit 15C causes the processing to proceed to Step S15.

The processing unit 15C determines whether or not the visual line information of the passerby faces the vehicle V with reference to the visual line information in the storage unit 15B (Step S15). For example, in a case where at least one piece of visual line information that faces a predetermined direction exists, the processing unit 15C determines that the visual line information of the passerby faces the vehicle V. In a case where it is determined that the visual line information of the passerby faces the vehicle V (Yes in Step S15), the processing unit 15C causes the processing to proceed to Step S16.

The processing unit 15C executes first processing of deciding a first motion of the vehicle V that gives way to the passerby (Step S16). The first processing is processing of deciding and executing processing corresponding to the target passerby in a case where the visual line information of the passerby faces the vehicle V. For example, the first processing is processing of delivering intension of giving way to the target passerby, and of executing the first motion of the vehicle V which corresponds to reaction of the passerby. The processing unit 15C functions as the decision unit 15C4 by executing the processing in Step S16. Furthermore, details of the first processing will be described later. When execution of the first processing is terminated, the processing unit 15C terminates the procedure illustrated in FIG. 3.

In a case where it is determined that the visual line information of the passerby does not face the vehicle V (No in Step S15), the processing unit 15C causes the processing to proceed to Step S17. The processing unit 15C determines whether or not the passerby makes an action of giving way on the basis of an image (Step S17). For example, the processing unit 15C specifies an action of the passerby on the basis of a captured image of the passerby in a case where the visual line of the target passerby does not face the vehicle. For example, the processing unit 15C specifies an action in which the passerby gives way, an action in which the passerby gives an appreciation, an action in which the passerby is not standing still, an action in which the center of gravity of the passerby is inclined to a front side, and the like. In the case of specifying the action in which the passerby gives way, the processing unit 15C determines that the passerby makes an action of giving way. For example, in the case of specifying any one action among the action in which the passerby gives an appreciation, the action in which the passerby is not standing still, and the action in which the center of gravity of the passerby is inclined to a front side, the processing unit 15C determines that the passerby does not make an action of giving way. The processing unit 15C functions as the second determination unit 15C8 by executing the processing in Step S17. In a case where it is determined that the passerby does not makes an action of giving way (No in Step S17), the processing unit 15C causes the processing to proceed to Step S18.

The processing unit 15C executes second processing of deciding a second motion of the vehicle V which gives way to the target passerby (Step S18). The second processing is processing of deciding and executing processing of giving way to the passerby in a case where the visual line information of the passerby does not face the vehicle V. For example, the second processing is processing of stopping the vehicle V and of executing the second motion of the vehicle V which corresponds to the action of the passerby. The processing unit 15C functions as the decision unit 15C4 by executing the processing in Step S18. Furthermore, details of the second processing will be described later. When execution of the second processing is terminated, the processing unit 15C terminates the procedure illustrated in FIG. 3.

In a case where it is determined that the passerby makes an action of giving way (Yes in Step S17), the processing unit 15C causes the processing to proceed to Step S19.

The processing unit 15C executes third processing of deciding a third motion of the vehicle V with respect to the passerby (Step S19). The third processing is processing for executing a motion of the vehicle V which corresponds to an action of the target passerby in a case where the visual line information of the passerby does not face the vehicle V. For example, the third processing is processing of confirming the visual line information of the target passerby again in a case where the visual line of the passerby does not face the vehicle, and executing the third motion of the vehicle V on the basis of the visual line information and an action of the target passerby. The processing unit 15C functions as the decision unit 15C4 by executing the processing in Step S19. Furthermore, details of the third processing will be described later. When execution of the third processing is terminated, the processing unit 15C terminates the procedure illustrated in FIG. 3.

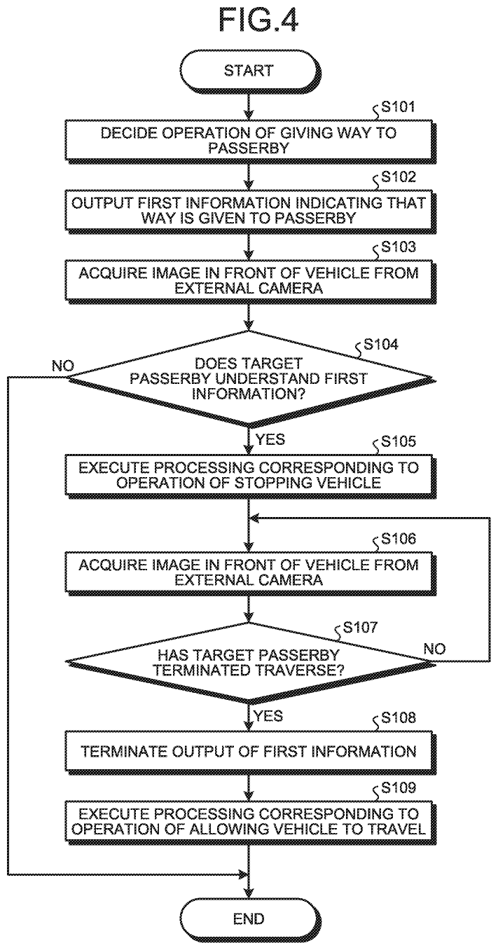

Next, an example of the first processing that is executed by the processing unit 15C of the control device 15 will be described with reference to a flowchart of FIG. 4. The flowchart illustrated in FIG. 4 illustrates an example of a procedure of deciding the first motion of the vehicle V which gives way to the passerby. The procedure illustrated in FIG. 4 is executed by the processing unit 15C when the processing unit 15C executes the processing in Step S16 illustrated in FIG. 3. When the procedure illustrated in FIG. 4 is terminated, the processing unit 15C returns to the procedure illustrated in FIG. 3.

The processing unit 15C decides an operation of giving way to the passerby (Step S101). The processing unit 15C outputs the first information indicating that way is given to the passerby (Step S102). For example, the processing unit 15C causes the external display device 14 to display the first information. As a result, for example, the in-vehicle system 1 displays the first information such as “please go ahead” with respect to the passerby as display of giving way. For example, the processing unit 15C may output the first information from a voice output device to the outside of the vehicle V. The processing unit 15C functions as the output control unit 15C6 by executing the processing in Step S102. When outputting the first information, the processing unit 15C causes the processing to proceed to Step S103.

The processing unit 15C acquires an image in front of the vehicle V from the external camera 12d (Step S103). The processing unit 15C determines whether or not the passerby understands the first information on the acquired image (Step S104). For example, in a case where a facial expression, a gesture, and the like of the target passerby can be extracted from the image by various methods using the artificial intelligence technologies or the deep learning technologies, the processing unit 15C determines that the passerby understands the first information. The processing unit 15C functions as the first determination unit 15C7 by executing Step S104.

In a case where it is determined that the target passerby does not understand the first information in Step S104 (No in Step S104), the processing unit 15C terminates the procedure illustrated in FIG. 4. That is, in a case where the target passerby does not understand the first information, the processing unit 15C executes the procedure illustrated in FIG. 3 again, and decides a motion of the vehicle V.

In addition, in a case where it is determined that the target passerby understands the first information (Yes in Step S104), the processing unit 15C causes the processing to proceed to Step S105. The processing unit 15C executes processing corresponding to an operation of stopping the vehicle (Step S105). For example, the processing unit 15C executes processing of performing control of stopping the vehicle V. The processing unit 15C functions as the travel control unit 15C5 by executing the processing in Step S105. When the vehicle V is stopped, the processing unit 15C causes the processing to proceed to Step S106. As a result, when the vehicle V stops, the target passerby can initiate traverse of a forward side of the vehicle V.

The processing unit 15C acquires an image in front of the vehicle V from the external camera 12d (Step S106). The processing unit 15C determines whether or not the target passerby terminates the traverse on the basis of the image that is acquired (Step S107). For example, the processing unit 15C detects a positional variation of the target passerby on the basis of the image that is acquired, and determines that the target passerby terminates the traverse in a case where a situation, in which the target passerby has moved from one side of the road R on which the vehicle V travels to the other side, can be detected.

In a case where it is determined that the target passerby has not terminated the traverse (No in Step S107), the processing unit 15C returns the processing to Step S106. That is, the processing unit 15C repeats the processing from Step S106 to Step S107 and waits termination of the traverse of the target passerby. In addition, in the case of detecting that the target passerby does not initiate the traverse, the processing unit 15C may terminate the procedure illustrated in FIG. 4, and may execute the procedure illustrated in FIG. 3 again.

In a case where it is determined that the target passerby has terminated the traverse (Yes in Step S107), the processing unit 15C causes the processing to proceed to Step S108. The processing unit 15C terminates output of the first information (Step S108). For example, the processing unit 15C makes a request for the external display device 14 to stop output of the first information. When output of the first information is terminated, the processing unit 15C causes the processing to proceed to Step S109.

The processing unit 15C executes processing corresponding to an operation of causing the vehicle V to travel (Step S109). For example, the processing unit 15C executes processing of performing control of allowing the vehicle V that is stopped to travel. The processing unit 15C functions as the travel control unit 15C5 by executing the processing in Step S109. When the vehicle V is allowed to travel, the processing unit 15C terminates the procedure illustrated in FIG. 4.

In a case where the visual line information of a passerby in front of the vehicle V faces the vehicle V, the above-described in-vehicle system 1 performs an operation of giving way to the passerby. Accordingly, communication with the passerby is attained on the basis of the visual line information of the passerby, and thus the in-vehicle system 1 can improve communication between the vehicle and the passerby. For example, in the in-vehicle system 1, when confirming the visual line information of the passerby who is likely to traverse a forward side of the vehicle V, even in a case where the passerby traverses a road without a crosswalk, it is possible to improve safety.

In a case where the visual line information of the passerby in front of the vehicle V faces the vehicle V, the in-vehicle system 1 outputs the first information indicating that way is given to the passerby to the passerby. Accordingly, the in-vehicle system 1 delivers information indicating that way is given to the passerby, and thus it is possible to improve communication between the vehicle and the passerby, and safety.

In a case where the first information is output to the passerby, when the passerby understands the first information, the in-vehicle system 1 stops the vehicle V, and thus it is possible to avoid a situation the vehicle V is stopped at random. Accordingly, the in-vehicle system 1 can suppress deterioration of convenience, and can improve communication between the vehicle and the passerby. In addition, when the vehicle V is stopped in a case where the passerby understands the first information, the in-vehicle system 1 can maintain stoppage of the vehicle V until traverse of the passerby is terminated.

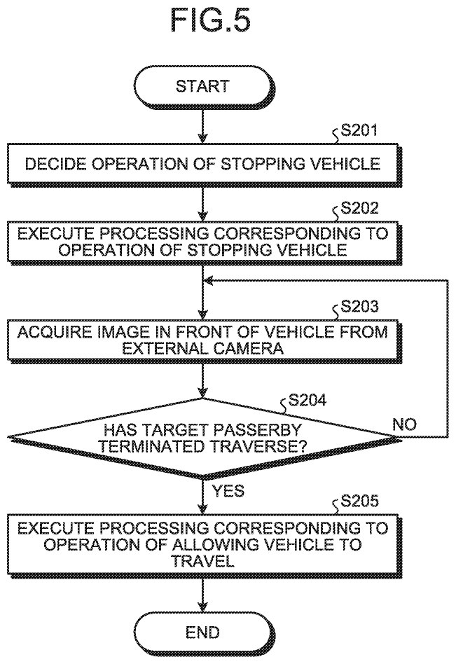

Next, an example of the second processing that is executed by the processing unit 15C of the control device 15 will be described with reference to a flowchart of FIG. 5. The flowchart illustrated in FIG. 5 illustrates an example of a procedure of deciding the second motion of the vehicle V which gives way to a passerby. The procedure illustrated in FIG. 5 is executed by the processing unit. 15C when the processing unit 15C executes the processing in Step S18 illustrated in FIG. 3. That is, the procedure illustrated in FIG. 5 is executed in a case where a passerby whose visual line information does not face the vehicle V does not give way. When terminating the procedure illustrated in FIG. 5, the processing unit 15C returns to the procedure illustrated in FIG. 3.

Since the passerby does not make an action of giving way, the processing unit 15C decides an operation of stopping the vehicle V (Step S201). The processing unit 15C executes processing corresponding to an operation of stopping the vehicle V (Step S202). For example, the processing unit 15C executes processing of performing control of stopping the travelling vehicle V. The processing unit 15C functions as the travel control unit 15C5 by executing the processing in Step S202. When the vehicle V is stopped, the processing unit 15C causes the processing to proceed to Step S203.

The processing unit 15C acquires an image in front of the vehicle V from the external camera 12d (Step S203). The processing unit 15C determines whether or not the target passerby has terminated traverse on the basis of the image that is acquired (Step S204). In a case where it is determined that the target passerby has not terminated traverse (No in Step S204), the processing unit 15C returns the processing to Step S203 described above. That is, the processing unit 15C repeats the processing from Step S203 to Step S204 and waits termination of the traverse of the target passerby.

In a case where it is determined that the target passerby has terminated the traverse (Yes in Step S204), the processing unit 15C causes the processing to proceed to Step S205. The processing unit 15C executes processing corresponding to an operation of allowing the vehicle V to travel (Step S205). For example, the processing unit 15C executes processing of performing control of allowing the vehicle V that is stopped to travel. The processing unit 15C functions as the travel control unit 15C5 by executing the processing in Step S205. When the vehicle V is allowed to travel, the processing unit 150 terminates the procedure illustrated in FIG. 5.

In a case where the visual line information of the passerby in front of the vehicle V does not face the vehicle V, and in a case where the passerby does not make an action of giving way, the above-described in-vehicle system 1 performs an operation of stopping the vehicle V. Accordingly, the in-vehicle system 1 decides the operation of stopping the vehicle V on the basis of the visual line information and the action of the passerby, and thus it is possible to improve communication with the passerby.

In a case where the visual line information of the target passerby does not face the vehicle V on a forward side of the vehicle V, the in-vehicle system 1 stops the vehicle V. Accordingly, it is possible to improve safety, for example, with respect to a passerby who traverses a road without recognizing the vehicle V.

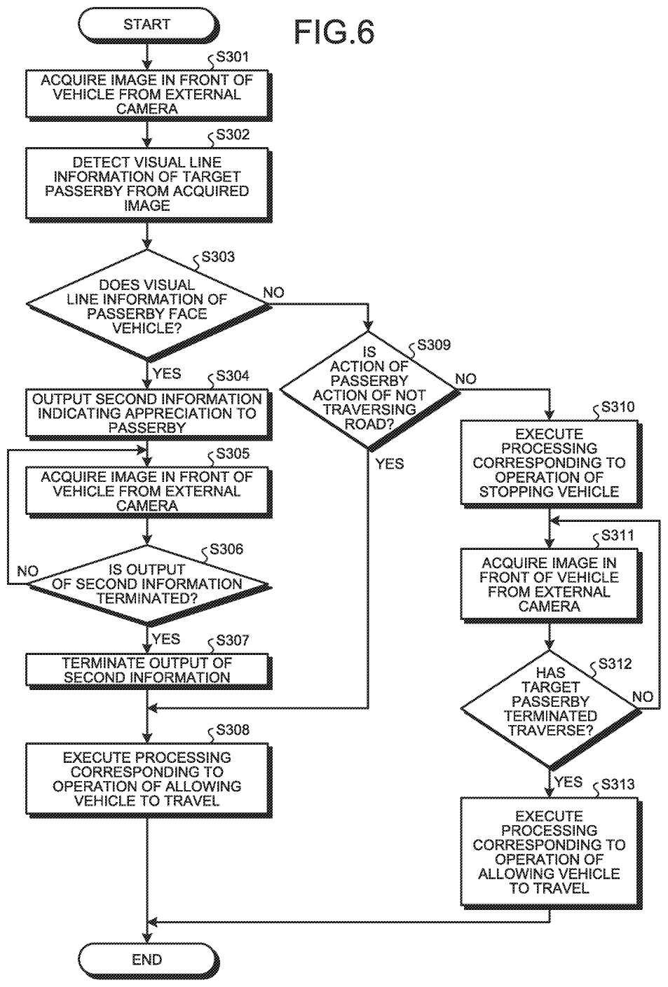

Next, an example of the third processing that is executed by the processing unit 15C of the control device 15 will be described with reference to a flowchart of FIG. 6. The flowchart illustrated in FIG. 6 illustrates an example of a procedure of deciding the third motion of the vehicle V with respect to a passerby. A procedure illustrated in FIG. 6 is executed by the processing unit 15C when the processing unit 15C executes the processing in Step S19 illustrated in FIG. 3. That is, the procedure illustrated in FIG. 6 is executed in a case where the passerby makes an action of giving way. When terminating the procedure illustrated in FIG. 6, the processing unit 15C returns to the procedure illustrated in FIG. 3.

The processing unit 15C acquires an image in front of the vehicle V from the external camera 12d (Step S301). The processing unit 15C detects visual line information of a target passerby from the image that is acquired (Step S302). For example, the processing unit 15C detects the visual line information of the target passerby on the basis of the image obtained by capturing an image in front of the vehicle V. The processing unit 150 functions as the second detection unit 15C3 by executing the processing in Step S302. When the detected visual line information is stored in the storage unit 15B, the processing unit 15C causes the processing to proceed to Step S303.

The processing unit 15C determines whether or not the visual line information of the passerby faces the vehicle V with reference to the visual line information in the storage unit 15B (Step S303). That is, the processing, unit 15C confirms the visual line information of the passerby whose visual line information is determined not to face the vehicle V again. For example, in a case where a state in which the visual line information does not face the vehicle V varies to a state in which the visual line information faces the vehicle V, the passerby may recognize the vehicle V and may be less likely to traverse a road. In a case where it is determined that the visual line information of the passerby faces the vehicle V (Yes in Step S303), the processing unit 15C causes the processing to proceed to Step S304.

The processing unit 15C outputs the second information indicating appreciation to the passerby (Step S304). For example, the processing unit 15C causes the external display device 14 to display second information. For example, the processing unit 15C may output the second information from a voice output device to the outside of the vehicle V. The processing unit 15C functions as the output control unit 15C6 by executing the processing in Step S304. When the second information is output, the processing unit 15C causes the processing to proceed to Step S305.

The processing unit 15C acquires an image in front of the vehicle V from the external camera 12d (Step S305). The processing unit 15C determines whether or not to terminate output of the second information on the basis of the image that is acquired (Step S306). For example, in the case of detecting a facial expression, a gesture, and the like of the passerby who understands the second information on the basis of the image in front of the vehicle V, the processing unit 15C determines that output of the second information is terminated. For example, the processing unit 15C may determine that output of the second information is terminated in a case where a constant time has passed after initiation of display of the second information, and the like. In a case where it is determined that output of the second information is not terminated (No in Step S306), the processing unit 15C returns the processing to Step S305 described above.

In a case where it is determined that output of the second information is terminated (Yes in Step S306), the processing unit 15C causes the processing to proceed to Step S307. The processing unit 15C terminates output of the second information (Step S307). For example, the processing unit 15C makes a request for the external display device 14 to stop output of the second information. When output of the second information is terminated, the processing unit 15C causes the processing to proceed to Step S308.

The processing unit 15C executes processing corresponding to an operation of allowing the vehicle V to travel (Step S308). For example, the processing unit 15C executes processing of performing control of allowing the vehicle V to travel, or maintaining travel of the vehicle V. The processing unit 15C functions as the travel control unit 15C5 by executing the processing in Step S308. When the vehicle V is allowed to travel, the processing unit 15C terminates the procedure illustrated in FIG. 6.

In addition, in a case where it is determined that the visual line information of the passerby does not face the vehicle V (No in Step S303), the processing unit 15C causes the processing to proceed to Step S309. The processing unit 15C determines whether or not an action of the passerby is an action of traversing a road on the basis of an image that is acquired (Step S309). For example, in a case where the passerby does not move, in a case where the passerby makes an action of giving way, and the like, the processing unit 15C determines the action of the passerby as an action in which the passerby does not traverse a road.

In a case where it is determined that the action of the passerby is an action in which the passerby does not traverse a road (Yes in Step S309), the processing unit 15C causes the processing to proceed to Step S308 described above. The processing unit 15C executes processing corresponding to an operation of allowing the vehicle V to travel (Step S308). When the vehicle V is allowed to travel, the processing unit 150 terminates the procedure illustrated in FIG. 6.

In a case where it is determined that the action of the passerby is not the action in which the passerby does not traverse a road (No in Step S309), that is, in a case where the passerby takes an action of traversing a road, the processing unit 15C causes the processing to proceed to Step S310. The processing unit 15C executes processing corresponding to an operation of stopping the vehicle V (Step S310). For example, the processing unit 15C executes processing of performing control of stopping the vehicle V that is travelling, or maintaining stoppage of the vehicle V. The processing unit 15C functions as the travel control unit 15C5 by executing the processing in Step S310. When the vehicle V is stopped, the processing unit 15C causes the processing to proceed to Step S311.

The processing unit 15C acquires an image in front of the vehicle V from the external camera 12d (Step S311). The processing unit 15C determines whether or not the target passerby has terminated the traverse on the basis of the image that is acquired (Step S312). In a case where it is determined that the target passerby does not terminate traverse (No in Step S312), the processing unit 15C returns the processing to Step S311 described above. That is, the processing unit 15C repeats the processing from Step S311 to Step S312, and waits termination of the traverse of the target passerby.

In a case where it is determined that the target passerby has terminated the traverse (Yes in Step S312), the processing unit 15C causes the processing to proceed to Step S313. The processing unit 15C executes processing corresponding to an operation of allowing the vehicle V to travel (Step S313). For example, the processing unit 15C executes processing of performing control of allowing the vehicle V that is stopped to travel or maintaining travel of the vehicle V. The processing unit 15C functions as the travel control unit 15C5 by executing the processing in Step S313. When the vehicle V is allowed to travel, the processing unit 15C terminates the procedure illustrated in FIG. 6.

In a case where the visual line information of the passerby in front of the vehicle V does not face the vehicle V, and in a case where the passerby does not make an action of giving way, the above-described in-vehicle system 1 performs a motion of the vehicle V which corresponds to the visual line information and the action of the passerby. Accordingly, communication with the passerby is attained even in a case where the visual line information of the passerby does not face the vehicle V, and thus the in-vehicle system 1 can improve communication between the vehicle and the passerby.

In a case where the visual line information of the target passerby does not face the vehicle V on a forward side of the vehicle V, when the passerby makes an action of giving way, the in-vehicle system 1 allows the vehicle V to travel. Accordingly, even in a case where the visual line information does not face the vehicle V, the in-vehicle system 1 decides a motion of the vehicle V after confirming the visual line information of the passerby again. Accordingly, it is possible to further improve communication with the passerby, and it is possible to suppress occurrence of accident.

Furthermore, the in-vehicle system 1 according to the embodiment of the invention is not limited to the above-described embodiment, and various modifications can be made in a range of the appended claims.

In the embodiment, description has been given of a case where the in-vehicle system 1 is an automatic driving system without a driver, but there is no limitation to the system. For example, the in-vehicle system 1 may be mounted in a vehicle that is driven by a driver. In this case, the in-vehicle system 1 may cause the display device 13 to display information indicating a motion of the vehicle V which is decided on the basis of the visual line information of the passerby. The in-vehicle system 1 may notify the driver of a possibility that the passerby may perform traverse. As a result, the in-vehicle system 1 allows the driver to recognize the motion of the vehicle V which is decided, and thus it is possible to improve safety.

The first detection unit 15C2 of the in-vehicle system 1 can detect a passerby from an image obtained by capturing an image in front of the vehicle V by using the artificial intelligence technologies or the deep learning technologies which are known. The second detection unit 15C3 of the in-vehicle system 1 can detect visual line information of the passerby who is detected by the first detection unit 15C2 from the image by using the artificial intelligence technologies or the deep learning technologies which are known.

In the above-described control device 15, respective units may be individually constructed, and the respective units may be connected in a manner capable of transmitting and receiving various electric signals. In addition, partial functions may be realized by another control device. In addition, the above-described program, application, various pieces of data, and the like may be appropriately updated, or may be stored in a server that is connected to the in-vehicle system 1 through an arbitrary network. For example, the entirety or parts of the above-described program, application, and various pieces of data, and the like may be downloaded as necessary. In addition, for example, with regard to the processing function of the control device 15, the entirety or arbitrary parts thereof may be executed, for example, by a CPU and the like, and a program that is analyzed and executed by the CPU and the like, or may be realized as hardware by a wired logic and the like.

The in-vehicle system according to the present embodiment can decide a motion of a vehicle on the basis of visual line information of passersby. As a result, the in-vehicle system can attain an effect capable of improving communication between the vehicle and the passersby on the basis of visual line information of the passersby.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An in-vehicle system, comprising:
a detection unit that detects visual line information of a passerby on the basis of an image obtained by capturing an image in front of a vehicle;
a decision unit that decides a motion of the vehicle on the basis of the visual line information of the passerby that is detected by the detection unit; and
an operation unit that performs processing corresponding to the motion of the vehicle that is decided by the decision unit, wherein
the decision unit decides a motion of the vehicle that gives way to the passerby in a case where the visual line information of the passerby faces the vehicle,
the operation unit performs processing of outputting first information that indicates that way is given to the passerby to the passerby,
the in-vehicle system further includes a first determination unit that determines whether or not the passerby understands the first information output by the operation unit on the basis of a captured image of the passerby,
in a case where the first determination unit determines that the passerby understands the first information, the decision unit decides an operation of stopping the vehicle, and
the operation unit performs processing corresponding to the operation of stopping the vehicle.

2. The in-vehicle system according to claim 1, wherein
the passerby is a person who is likely to traverse a forward side of the vehicle.

3. The in-vehicle system according to claim 1, further comprising:
a second determination unit that determines whether or not the passerby makes an action of giving way on the basis of a captured image of the passerby in a case where a visual line of the passerby does not face the vehicle, wherein
in a case where the second determination unit determines that the passerby makes an action of giving way, the decision unit decides an operation of allowing the vehicle to travel, and
the operation unit performs processing corresponding to the operation of allowing the vehicle to travel.

4. The in-vehicle system according to claim 2, further comprising:
a second determination unit that determines whether or not the passerby makes an action of giving way on the basis of a captured image of the passerby in a case where a visual line of the passerby does not face the vehicle, wherein
in a case where the second determination unit determines that the passerby makes an action of giving way, the decision unit decides an operation of allowing the vehicle to travel, and
the operation unit performs processing corresponding to the operation of allowing the vehicle to travel.

5. The in-vehicle system according to claim 3, wherein
in a case where the second determination unit determines that the passerby does not make an action of giving way, the decision unit decides an operation of stopping the vehicle or allowing the vehicle to travel slowly, and
the operation unit performs processing corresponding to the operation of stopping the vehicle or allowing the vehicle to travel slowly.
